(19) United States
(12) Patent Application Publication
(10) Pub. No.: US 2006/0059094 A1
(43) Pub. Date: Mar. 16, 2006

(54) Method and apparatus for digital rights management

(75) Inventors: Yun-sang Oh, Seoul (KR); Moon-sang Kwon, Seoul (KR); Kyung-im Jung, Seongnam-si (KR); Sang-sin Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/226,266

(22) Filed: Sep. 15, 2005

(30) Foreign Application Priority Data
Sep. 15, 2004 (KR) 10-2004-0073835

(51) Int. Cl. G06F 17/60

(52) U.S. Cl. 705/51

(57) ABSTRACT

Disclosed are a method and an apparatus for digital rights management that can make a host device effectively use rights objects stored in a portable storage device. The method includes requesting a portable storage device to search for a rights object that can execute a specified content object, selecting a rights object to be consumed by confirming information about the rights object received from the portable storage device as a result of the request, and executing the content object by consuming the selected rights object.

### CROSS-REFERENCE TO RELATED APPLICATION

This application claims priority from Korean Patent Application No. 10-2004-0073835 filed on Sep. 15, 2004 in the Korean Intellectual Property Office, the disclosure of which is incorporated herein by reference in its entirety.

### BACKGROUND OF THE INVENTION

1. Field of the Invention

The present invention relates to a method and an apparatus for digital rights management, and more particularly, to a method and an apparatus for digital rights management that uses rights objects stored in a portable storage device.

2. Description of the Related Art

Recently digital rights management (hereinafter referred to as “DRM”) has been researched actively and commercial services using DRM have already been implemented or will be implemented. DRM is a technical concept to protect digital content that can be readily copied and distributed without permission.

Some efforts have been made to protect digital content. Conventionally, digital content protection has concentrated on preventing those without permission to access digital content. Specifically, only those people who have paid fees are permitted to access the digital content, and persons who have not paid the charges are denied access to the digital content. However, the digital content can be readily copied, reused, processed and distributed to third parties according to the characteristics of the digital data. Accordingly, when a person who has paid the fees accesses the digital content and intentionally distributes it to a third party, the third party can use the digital content without paying the fees, which has produced a number of problems.

In order to solve these problems, in DRM, the digital content is encrypted and distributed, and a specified license called a rights object (RO) is needed to use the encrypted digital content.

Referring to FIG. 1, a device 110 desiring to use digital content can obtain the desired digital content from a content provider 120. In this case, the digital content supplied by the content provider 120 is encrypted content, and in order to use the encrypted digital content (hereinafter referred to as content object), a rights object is required.

The device 110 can obtain the rights object containing a right to execute the content object from a rights object issuer 130 by paying fees. The right included in the rights object may be a content encryption key that can decode the content object. In this case, the rights object issuer 130 reports details of the rights object issuance to the content provider 120, and according to circumstances, the rights object issuer 130 and the content provider 120 may be one entity.

The device 110 having obtained the rights object can use the content object via the rights object.

Meanwhile, the content object can be freely copied and distributed to other devices. However, the rights object includes information about use limitations, the duration of use, and others, with respect to permission to use the content through the rights object, or the rights object includes information about the limitation of the number of times and so on for permission to copy the rights object. Accordingly, the rights object, unlike the content object, is subject to reuse and copy limitations. Accordingly, DRM can effectively protect digital content.

The user stores such a rights object in a host device, such as a mobile phone and a PDA, that intends to execute multimedia data. However, in order to simplify the storage and distribution of the content object and the rights object, new technology to manage the rights object through a portable storage device such as a memory stick, a multimedia card (MMC), and others has recently been introduced. Accordingly, there is demand for a method to make the host device effectively use the rights object stored in the portable storage device.

### SUMMARY OF THE INVENTION

Illustrative, non-limiting embodiments of the present invention overcome the above disadvantages, and other disadvantages not described above.

Accordingly an aspect of the present invention is to make a host device effectively consume rights objects stored in a portable storage device.

Additional advantages, objects and features of the invention will be set forth in part in the description which follows and in part will become apparent to those skilled in the art upon examination of the following or may be learned from practice of the invention.

According to an exemplary embodiment of the present invention, a digital rights management method includes requesting a portable storage device to search for a rights object that can execute a specified content object, selecting a rights object to be consumed by confirming information about a rights object received from the portable storage device as a result of the request, and executing the content object by consuming the selected rights object.

According to another exemplary embodiment of the present invention, a digital rights management method includes receiving a request for searching for a rights object that can execute a specified content object from a host device, searching for a rights object that can execute the content object, and transmitting the searched rights object and information about the searched rights object to the host device.

According to a further exemplary embodiment of the present invention, a host device includes an interface module for connecting with a portable storage device, a control module that requests a search for a rights object which can execute a specified content object to the portable storage device through the interface module, and a content execution module that executes the content object by consuming a rights object received from the portable storage device through the interface module as a result of the request.

According to a still further exemplary embodiment of the present invention, a portable storage device includes an interface module for connecting with a host device, a storage module that stores rights objects and state information of the rights objects, and a control module that searches for rights object stored in the storage module according to a request for searching for the rights object, which can execute a specified content object, received from the host device connected through the interface module, and transmits the searched rights object to the host device through the interface module.

### BRIEF DESCRIPTION OF THE DRAWINGS

The above aspects and advantages of the present invention will become more apparent by describing in detail exemplary embodiments thereof with reference to the attached drawings in which:

FIG. 1 is a view illustrating the general DRM concept;

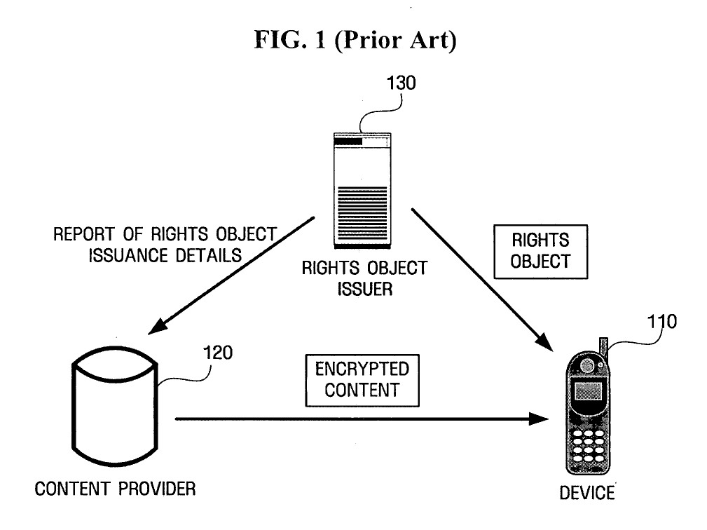

FIG. 2 is a view illustrating a DRM concept according to an exemplary embodiment of the present invention;

FIG. 3 is a flowchart illustrating a process of mutual authentication between a host device and a portable storage device according to an exemplary embodiment of the present invention;

FIG. 4 is a flowchart illustrating a process of using a rights object according to an exemplary embodiment of the present invention;

FIG. 5 is a flowchart illustrating a process of using a rights object according to another exemplary embodiment of the present invention;

FIG. 6 is a flowchart illustrating a process of updating a rights object according to an exemplary embodiment of the present invention;

FIG. 7 is a block diagram illustrating the construction of a host device according to an exemplary embodiment of the present invention; and

FIG. 8 is a block diagram illustrating the construction of a portable storage device according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings.

The aspects and features of the present invention and methods for achieving the aspects and features will be apparent by referring to the exemplary embodiments to be described in detail with reference to the accompanying drawings. However, the present invention is not limited to the embodiments disclosed hereinafter, but will be implemented in diverse forms. Certain material defined in the description, such as construction details and elements, are specific details only provided to assist those of ordinary skill in the art in a comprehensive understanding of the invention, and the present invention is only defined within the scope of appended claims. In the whole description of the present invention, the same drawing reference numerals are used for the same elements across various figures.

Several terms used herein will first be described in a brief manner for a better understanding of the present description. Thus, it should be noted that this description is not intended to limit the scope of protection of the present invention as defined by the appended claims.

Public-Key Cryptography

Public-key cryptography is also referred to as asymmetric cryptography because the key used in decrypting data and the key used in encrypting the data are different. Public-key cryptography uses a public key/private key pair. The public key need not be kept secret and can be made public, while the private key must be known only by a specific device. Examples of public-key encryption algorithms are Diffie-Hellman, RSA, El Gamal, and Elliptic Curve cryptography.

Symmetric-Key Cryptography

Symmetric-key cryptography is also referred to as secret key cryptography; in symmetric-key cryptography the key used to encrypt data and the key used to decrypt the data are the same. An example of such a symmetric key cryptography method is Data Encryption Standard (DES), which is the most widely used symmetric key method. Although, applications adopting the Advanced Encryption Standard (AES) method have increased.

Digital Signature

A digital signature is used to represent that a document has been drafted by the signatory. Examples of digital signature methods include RSA, ElGamal, DSA, and Schnorr.

Portable Storage Device

The portable storage device used in the present invention comprises a non-volatile memory with the properties of being readable, writable and erasable, like a flash memory, has specified data operations, and is a storage device that can be connected to a host device. Examples of such a storage device are smart media, memory sticks, compact flash (CF) cards, XD cards, and multimedia cards.

Host Device

The host device used in the present invention refers to a multimedia device capable of directly using content object through a rights object stored in the portable storage device, and which can be connected to the portable storage device. Examples of such a host device are a mobile phone, PDA, notebook computer, desktop computer, and a digital TV.

Rights Object

A rights object is a sort of license defining the rights of use of a content object, use constraint information about the content object, copy constraint information of the rights object, a rights object ID, a content ID, and others.

The right to use the content object may be a content encryption key (hereinafter referred to as “CEK”) that can decode the content object. The CEK decodes the content object to be used by a device, and the host device can use the content object after receiving the CEK from the portable storage device in which the rights object is stored.

The use constraint information is information that indicates the limitations on using the rights object in order to execute a content object. The use constraint information may include a use date constraint, a use count constraint, a use interval constraint, and an accumulated use constraint.

The use date constraint specifies the date limitation for using the content object. Accordingly, if the use date constraint is set, a host device can use the content object via the corresponding rights object for the duration after/before a specified date.

The use count constraint specifies the number of times the content object can be used. For example, if the use count constraint is set to “N” in the rights object, a host device can use the content object N times.

The use interval constraint specifies the interval of time during which the content object can be used. For example, if the use interval constraint is set to one week, a host device can use the content object via the rights object for one week from the time when the corresponding rights object is first used.

The accumulated use constraint specifies the whole interval of time during which the content object can be used. For example, if the accumulated use constraint of the rights object is set to 10 hours, a host device can use the content object for 10 hours. In this case, the host device is not limited by date or number of times when using the content object.

The copy constraint information is information that indicates the limitation on the number of times the rights can be copied or moved. The copy constraint information may include copy constraint information and movement constraint information.

To copy a rights object is to transmit the rights object to another device while maintaining the same rights object in the present device.

To move a rights object is to transmit the rights object existing in the present device to another device while deleting the corresponding rights object from the present device.

Accordingly, the user can copy or move the rights object stored in the host device or portable storage device to another host device or portable storage device as many times as is detailed in the rights object.

The rights object ID is an identifier for identifying a specific rights object among the existing rights objects.

The content ID is an identifier of the content object for identifying the content object that can be executed via the rights object.

Other rights objects are described in detail in the specifications: OMA DRM Enabler v1.0, 2002, Open Mobile Alliance or OMA DRM v2.0 draft, 2004, Open Mobile Alliance.

State Information

State information as used in the present invention is information that indicates the degree of rights object usage. For example, if the accumulated use constraint information of the rights object is set to 10 hours and the host device has used the content object for four hours, the state information indicates the time (i.e., four hours), or the remaining time (i.e., six hours).

The state information may be included in the rights object, or the device that stores the rights object may manage the state information together with the rights object as separate information.

Hereinafter, exemplary embodiments of the present invention will be described in detail with reference to the accompanying drawings.

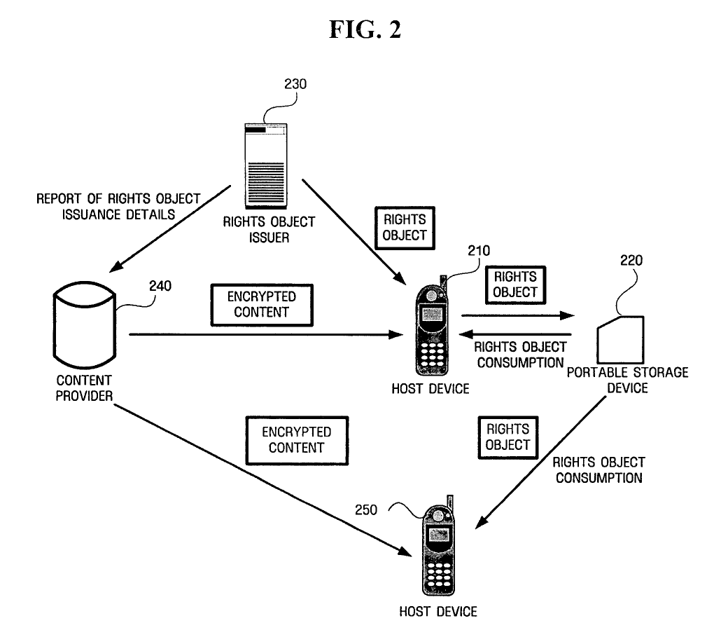

FIG. 2 is a view illustrating a DRM concept according to an exemplary embodiment of the present invention.

A user can obtain a content object from a content provider 240 through a host device 210. Also, the user can purchase a rights object that can execute the content object from a rights object issuer 230.

The purchased rights object may be stored in the host device 210 or a portable storage device 220 according to an exemplary embodiment of the present invention. In addition, one or more rights objects may be stored in the portable storage device 220 upon manufacture.

In this case, the host device 210 may use the rights object stored in the portable storage device 220 in order to use the content object. The host device 210 having used the rights object updates and transmits state update information of the corresponding rights object according to the degree of use of the rights object to the portable storage device 220. The portable storage device updates the state information of the corresponding rights object using the received state update information.

Another host device 250 can use the content object via the rights object stored in the portable storage device 220. According to circumstances, the rights object stored in the portable storage device 220 may be moved or copied to another host device 250. Accordingly, if the portable storage device 220 is used, the host devices 210 and 250 can easily share the rights object within the limited range of the use constraint information or the copy constraint information set in the rights object. Additionally, by storing the rights objects in the portable storage device 220, the data storage capability of the host device 210 can be improved and the rights objects can be managed easily.

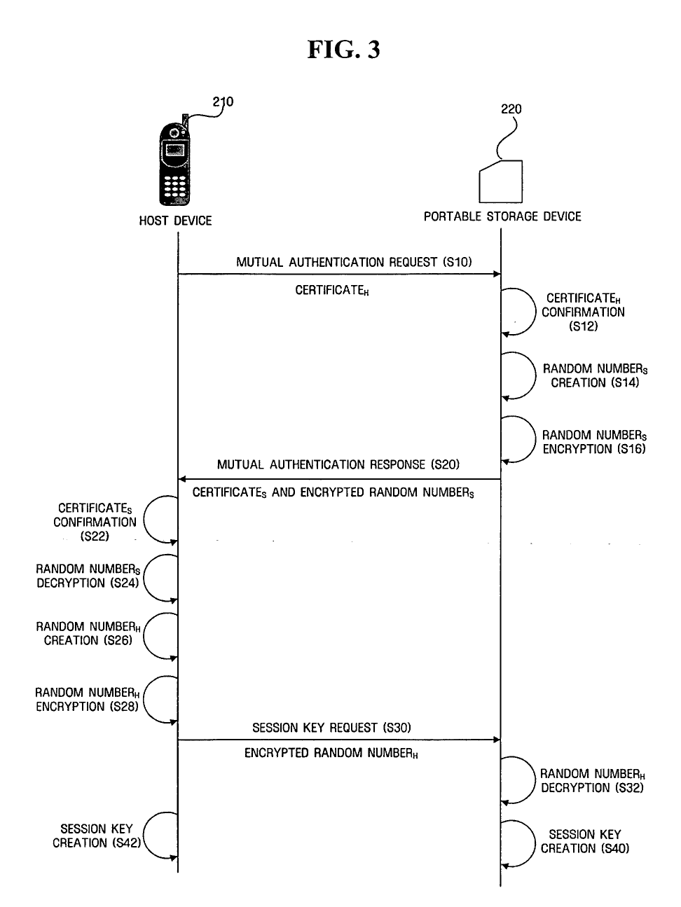

The host device 210 performs a mutual authentication with the portable storage device 220 before it is linked to and exchanges data with the portable storage device 220. The mutual authentication is a basic process for maintaining the security of data that is exchanged between the host device 210 and the portable storage device 220, of which a detailed explanation will be made with reference to FIG. 3.

FIG. 3 is a flowchart illustrating a mutual authentication process between a host device and a portable storage device according to an exemplary embodiment of the present invention.

In explaining the mutual authentication with reference to FIG. 3, a subscript “H” means that data belongs to a host device 210 or is created by the host device, and a subscript “S” means data that belongs to a portable storage device 220 or is created by the portable storage device.

The host device 210 and the portable storage device 220 may have their own pair of encryption keys, which are used for public-key encryption.

The host device 210 first sends a request for mutual authentication to the portable storage device 220 (S10). Along with the request for mutual authentication, the host device 210 sends the portable storage device 220 its public key. The public key of the host device 210 may be sent through a certificate_{H} of the host device 210 issued by a certification authority.

The portable storage device 220 that has received the certificate_{H} can ascertain whether the host device 210 is authorized, and can obtain the public key of the host device 210 from the certificate_{H}.

The portable storage device 220 confirms the certificate_{H} of the host device 210 in step S12. In this case, the portable storage device 220 judges if the term of validity of the certificate_{H} of the host device 210 has expired, and confirms that the certificate_{H} is valid using a certificate revocation list (hereinafter referred to as “CRL”). If the certificate_{H} of the host device 210 is no longer valid or it is registered in the CRL, the portable storage device 220 can reject mutual authentication with the host device 210. By contrast, if it is confirmed that the certificate_{H} of the device 210 is valid, the portable storage device 220 can obtain the public key of the host device 210 from the certificate_{H}.

Upon confirming the validity of the certificate_{H}, the portable storage device 220 creates a random numbers (S14) in order to answer the request for mutual authentication, and encrypts the created random number_{S} with the public key of the host device 210 (S16).

The encrypted random numbers is transmitted to the host device 210 together with the public key of the portable storage device 220 as a response to the mutual authentication request (S20). In this case, the public key of the portable storage device 220 may also be included in the certificates of the portable storage device 220 to be transmitted to the host device 210.

Using its CRL the host device 210 can confirm that the portable storage device 220 is an authorized device by confirming the validity of the certificate_{H} of the portable storage device 220 (S22). Meanwhile, the host device 210 can obtain the public key of the portable storage device 220 through the certificate of the portable storage device 220, and it can obtain the random numbers by decrypting the encrypted random number_{S} with its private key (S24).

The host device 210 having confirmed that the portable storage device 220 is an authorized device also creates a random number_{H} (S26), and encrypts the random number_{H} with the public key of the portable storage device 220 (S28).

Thereafter, the host device 210 transmits the encrypted random number_{H} along with a request for session key creation (S30).

The portable storage device 220 receives and decrypts the encrypted random number_{H} with its private key (S32). Accordingly, the host device 210 and the portable storage device 220 can share the random numbers they created and the random numbers created by their counterparts, and a session key can be created using the two random numbers (random number_{H} and random number_{S}) (S40 and S42). In the present embodiment, both the host device 210 and the portable storage device 220 create random numbers that are then used to create the session key, whereby the overall randomness is greatly increased, thereby making the mutual authentication more secure.

The host device 210 and the portable storage device 220 having created the session keys may confirm that the session key created by one party is the same as that of its counterpart.

The host device 210 and the portable storage device 220 having shared the session key can encrypt the data to be transmitted between them with the session key, and they can decrypt the received data with the session key, so that security can be ensured during data transmission.

Mutual authentication as described above is just an example of a process in which the host device 210 and the portable storage device 220 mutually confirm that they are authorized devices and share the session key. Accordingly, in order to create a common session key, a mutual authentication process similar to this may be performed.

Symmetric key encryption may be used for the aforementioned process. However, the present invention is not limited thereto. The host device 210 and the portable storage device 220 may use a public key encryption method whereby the host device or the portable storage device encrypt data to be transmitted with a public key of the portable storage device or the host device and decrypt the received data with their private keys.

In the exemplary embodiments of the present invention, the host device 210 and the portable storage device 220 can encrypt data transmitted between them with the session key or the opposite party's public key, and they decrypt the received data with the session key or their own private keys.

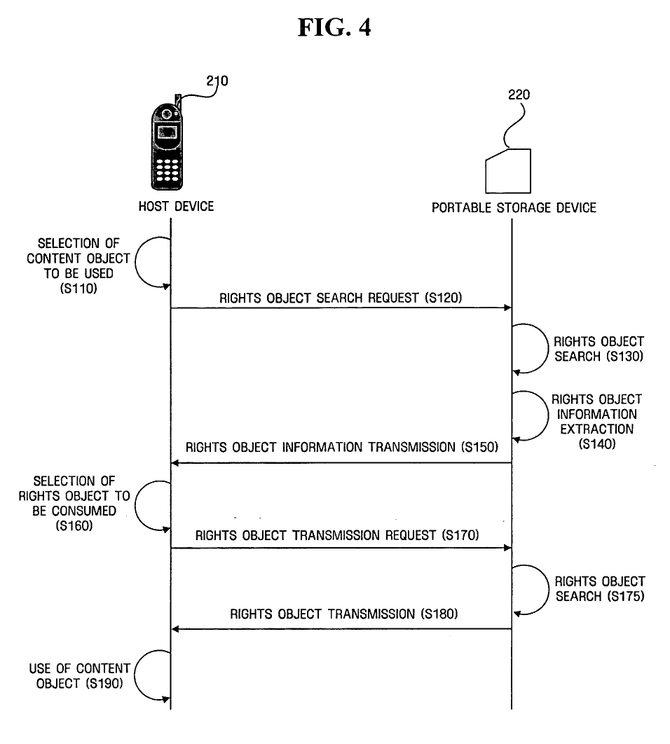

FIG. 4 is a flowchart illustrating a process of using a rights object according to an exemplary embodiment of the present invention.

The host device 210 having completed the mutual authentication with the portable storage device 220 selects a content object among content objects stored therein or received from other devices (S110).

The host device 210 sends a request for a search for a rights object that can execute the selected content object to the portable storage device 220 in order to use the selected content object (S120). In this case, the host device 210 can also transmit a content ID for identifying the selected content object.

The portable storage device 220 having received the rights object search request searches for the rights object that can execute the corresponding content object using the received content ID (S130).

If the rights object is found, the portable storage device 220 extracts information about the rights object (S140). The information about the rights object may include a rights object ID for identifying the corresponding rights object, information about a storage where the rights object is stored among the storage space of the portable storage device 220 (this may be a physical or logical address; hereinafter referred to as storage position), use constraint information of the rights object, copy constraint information of the rights object, and state information.

Meanwhile, if plural rights objects are searched for in the rights object search process (S130), i.e., if plural rights objects that can execute the content object requested by the host device 210 are searched for, the portable storage device 220 can extract rights object information for the respective rights objects.

The extracted rights object information is transmitted to the host device 210 as a reply to the rights object search request (S150). In this case, the portable storage device 220 may actively transmit the rights object information to the host device 210, or permit the host device 210 to access the extracted rights object information.

The host device having obtained the rights object information decides whether to use the corresponding rights object. In the case in which information about plural rights objects is obtained, the host device 210 may select one of the rights object to be used (S160). Such a selection may be made by a user or by the host device itself according to a rule previously set in the host device 210. For example, a rights object having the smallest number of allowed uses may be preferentially selected.

The host device 210, having decided the rights object to be used, requests transmission of the corresponding rights object to the portable storage device 220 (S170). When the transmission of a rights object is requested, the host device 210 can also transmit identification information for identifying the corresponding rights object (for example, a rights object ID or storage position information).

The portable storage device 220, having received the rights object transmission request, searches for the corresponding rights object using the identification information received with the rights object transmission request (S175).

The searched rights object is transmitted to the host device 210 (S180). In this case, the portable storage device 220 may transmit the searched rights object, or permit the host device 210 to access the searched rights object.

The host device 210 can use the content object by using the rights object obtained from the portable storage device 220 (S190).

If the host device 210 already knows the information about the rights object that can execute the content object, steps S120 to S150 can be omitted. For this, the host device 210 may obtain the rights object information from the portable storage device 220 in advance.

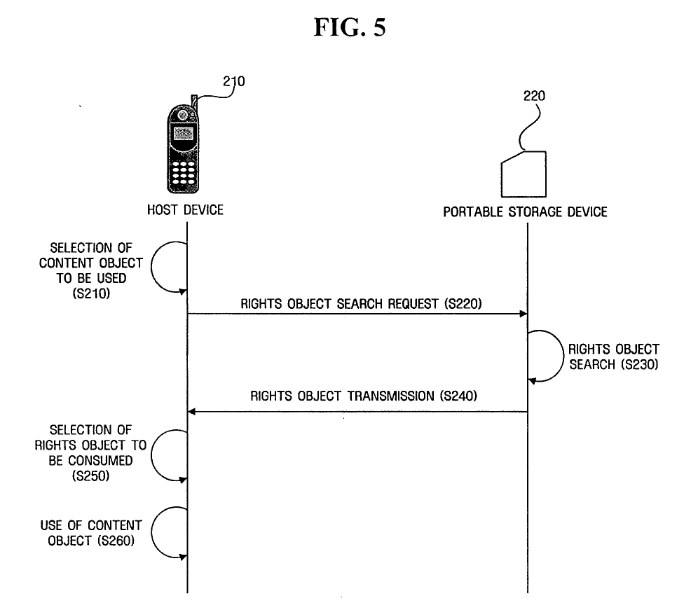

FIG. 5 is a flowchart illustrating a process of using a rights object according to another exemplary embodiment of the present invention.

In the illustrated process, steps S210 to S230 may be understood to be the same as steps S110 to S130 of FIG. 4.

The portable storage device 220, having found the rights object, transmits it to the host device 210 (S240). In this case, if plural rights objects are searched for, the portable storage device 220 can transmit all the found rights objects to the host device 210.

Meanwhile, the portable storage device 220 may also transmit the storage position of the corresponding rights object when transmitting the rights object. Additionally, if state information of the rights object is managed separately from the rights object, the portable storage device 220 can transmit the state information of the rights object together with the rights object.

The host device 210, having obtained the rights object, can select the rights object to be used, as in step S160 of FIG. 4 (S250).

If the rights object to be used is selected, the host device 210 uses the content object via the selected rights object (S260). If the host device 210 receives plural rights objects from the portable storage device 220, it may delete the rights objects that are not selected when using the content object.

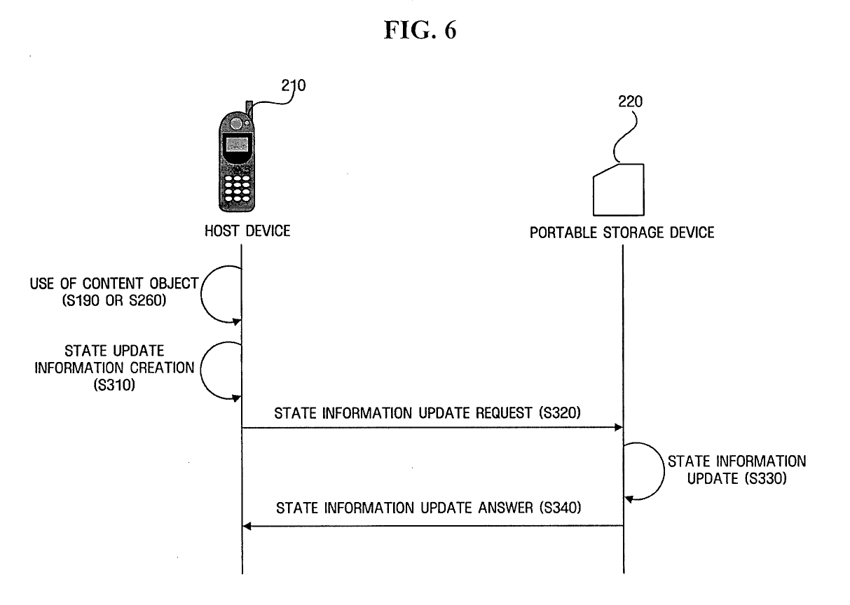

FIG. 6 is a flowchart illustrating a process of updating a rights object according to an exemplary embodiment of the present invention.

The host device 210 having used the content object via the rights object (S190 or S260) creates state update information to update the state information of the corresponding rights object according to the degree of rights object usage S310.

The state update information is information to update the state information of the rights object, which has already been used or is being used. For example, if the time during which the corresponding rights object is additionally used is four hours in a state where the accumulated use constraint information of the rights object is set to 10 hours and the state information of the corresponding rights object indicates that the content object has been used for two hours, the host device can create state update information indicating that the rights object has been used for a total of six hours.

The host device 210, having created the state update information, sends a request for an update of the state information to the portable storage device 220 (S320). In this case, the host device 210 can also transmit the state update information that it created and the rights object identification information subject to update (for example, the rights object ID for identifying the rights object or the storage position of the rights object).

The portable storage device 220 updates the state information of the corresponding rights object through the state update information and the rights object identification information (S330). Update of the state information may be performed in a manner that the rights object subject to update is searched for through the rights object identification information received with the state information update request, and the searched rights object state information is replaced by the state update information received with the state information update request.

The portable storage device 220, having updated the state information of the rights object, can report that the update is properly performed by sending a rights object update answer to the host device 210 (S340).

If no answer to the rights object update is received after a specified time elapses after the rights object update is requested, the host device 210 can re-send the rights object update request to the portable storage device 220.

In the embodiments of the present invention as described above, it is preferable for all the information transmitted between the portable storage device 220 and the host device 210 to be encrypted prior to transmission. The portable storage device 220 and the host device 210 can perform encryption/decryption using a public key and a private key based on the public key encryption method before the portable storage device and the host device complete the mutual authentication, and they can perform encryption/decryption using a session key, created as a result of the mutual authentication, after mutual authentication is completed.

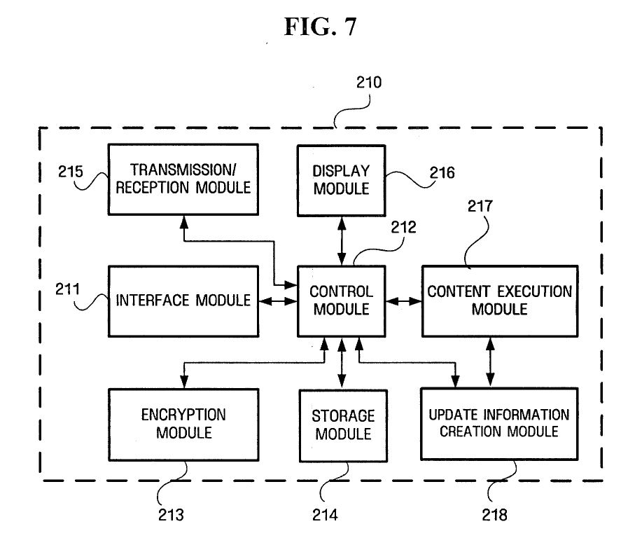

FIG. 7 is a block diagram illustrating the construction of a host device according to an exemplary embodiment of the present invention.

Modules used in the present embodiment and the following embodiment include software or hardware elements, such as a field-programmable gate array (FPGA) or an application-specific integrated circuit (ASIC) to perform a specific function. Modules may be configured to reside in an addressable storage medium or to reproduce one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute in one or more CPUs in a device or a portable storage device.

The host device 210 includes an encryption module 213 having a security function, a storage module 214 having a storage function, an interface module 211 enabling data exchange with a portable storage device 220, and a control module 212 controlling each module in order to perform the DRM process. The host device 210 also includes a transmission/reception module 215 for performing data transmission/reception with an external device or a system, a display module 216 for displaying the content as used, a content execution module 217 for executing the content object, and an update information creation module 218 for creating state update information.

The transmission/reception module 215 enables the host device 210 to perform wire/wireless communications with a content issuer or a rights object issuer. The host device 210 can obtain the rights object or the content object from the outside through the transmission/reception module 215.

The interface module 211 functions so that the host device 210 can be connected with the portable storage device 220. Basically, connection of the host device 210 to the portable storage device 220 means electrical interconnection between the interface modules of the portable device 220 and the host device 210. However, this is exemplary, and the term “connection” also includes the portable storage device and the host device communicating through a wireless medium (no physical connection).

The encryption module 213 encrypts the data transmitted to the portable storage device 220 at the request of the control module 212, or decrypts the encrypted data received from the portable storage device 220. The encryption module 213 can perform at least one of a secret key encryption method and a public key encryption method, and one or more encryption modules may exist to perform both encryption methods.

Specifically, rights objects are stored in an encrypted form, and the host device 210 can encrypt the rights objects through the encryption module 213, using a distinct encryption key that cannot be read by other devices. Furthermore, when moving or copying a rights object to another device or to the portable storage device, the encrypted rights object can be decrypted using the distinct encryption key. The rights object can be encrypted by use of a symmetric key encryption method using the distinct encryption key. Furthermore, it is also possible to encrypt the rights object with the public key of the host device 210, and to decrypt it with the private key of the host device 210, as necessary.

Additionally, the encryption module 213 may create the random numbers required during the mutual authentication process.

The storage module 214 stores encrypted content, a rights object, a certificate and the CRL of the host device 210.

When the host device 210 is connected to the portable storage device 220, the control module 212 may control the mutual authentication process with the portable storage device 220. Further, the control module 212 may create and transmit a message to the portable storage device 220 connected to the host device 210 to request a search for the rights object that can execute the content object. When the search for the rights object is requested, the control module 212 can also transmit the content ID for identifying the content object to be executed in addition to the message.

If the rights object or the rights object information is obtained from the portable storage device 220 as a result of the rights object search request, the control module 212 decides whether to use the corresponding rights object. The rights object information may include a rights object ID for identifying the corresponding rights object, a storage position of the rights object, use constraint information of the rights object, and copy constraint information of the rights object.

If plural rights objects or information about plural rights objects are obtained, the control module 212 may select one of the rights objects to be used. Such a selection may be made by a user or by the control module itself according to a rule set previously. For example, a rights object having the smallest number of allowed use times may be preferentially selected.

The control module 212, having decided the rights object to be used, may create a message to request transmission of the corresponding rights object. When transmission of the rights object is requested, the control module 212 can also transmit identification information for identifying the corresponding rights object (for example, a rights object ID or storage position information of the corresponding rights object).

Additionally, if the content execution module 217 executes the content via the rights object, the control module 212 can send a request for an update of the state information of the corresponding rights object to the portable storage device 220. In this case, the control module 212 can also transmit the state update information created by the update information creation module 218 and the rights object identification information subject to update (for example, the rights object ID for identifying the rights object or the storage position information of the rights object) in addition to the request message.

The respective request message created by the control module 212 may be transferred to the portable storage device 220 through the interface module 211, and an answer of the portable storage device 220 to the request may be transferred to the control module 212 through the interface module.

The display module 216 displays the content object whose use is authorized through a rights object so that a user can see it while using it (for example, while playing or executing the content). The display module 216 may be a liquid crystal display such as a TFT LCD or an organic EL.

The content execution module 217 executes the content object via the rights object received as an answer of the portable storage device 220 to the rights object request from the control module 212. For example, if the content refers to a moving image, the content execution module 217 may be an MPEG decoding module that can reproduce the moving image.

The update information creation module 218 creates the state update information for updating the state information of the rights object as a result of the rights object usage by the content execution module 217. For example, if the time during which the corresponding rights object is additionally used for four hours in a state where the accumulated use constraint information of the rights object is set to 10 hours and the state information of the corresponding rights object indicates that the content object has been used for two hours, the host device can create state update information indicating that the rights object has been used for a total of six hours.

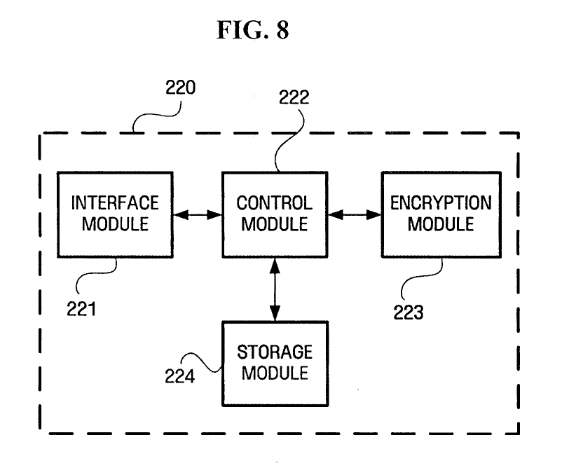

FIG. 8 is a block diagram illustrating the construction of a portable storage device according to an exemplary embodiment of the present invention.

In order to perform the DRM process, the portable storage device 220 includes an encryption module 223 having a security function, a storage module 224 having a storage function, an interface module 221 enabling data exchange with a host device 210, and a control module 222 for controlling each module in order to perform the DRM process.

The interface module 221 functions so that the portable storage device 220 can be connected with the host device 210.

Basically, connection of the portable storage device 220 to the host device 210 means electrical interconnection between the interface modules of the portable device 220 and the host device 210. However, this is exemplary, and the term “connection” also includes the portable storage device and the host device being in a state that mutual communication can be conducted through a wireless medium.

The encryption module 223 encrypts the data transmitted to the host device 210 at the request of the control module 222, or decrypts the encrypted data received from the host device 210. The encryption module 223 can perform not only a public key encryption method but also a secret key encryption method, and one or more encryption modules may exist to perform both encryption methods.

Specifically, rights objects are stored in an encrypted form, and the portable storage device 220 can encrypt the rights objects through the encryption module 223 using a distinct encryption key that cannot be read by other devices. Furthermore, when moving or copying a rights object to another device, the encrypted rights object can be decrypted using the distinct encryption key. The rights object can be encrypted by use of a symmetric key encryption method using the distinct encryption key. Furthermore, it is also possible to encrypt the rights object with the public key of the portable storage device 220 and to decrypt it with the private key of the portable storage device 220, as necessary.

Additionally, the encryption module 223 may create the random numbers required for the mutual authentication process.

The storage module 224 stores encrypted content, a rights object, a certificate and the CRL of the portable storage device 220. The rights objects stored in the storage module 224 may be rights objects obtained from another device (for example, the host device 210), or rights objects stored when the portable storage device 220 is manufactured.

When the portable storage device 220 is connected to the host device 210, the control module 222 may control the mutual authentication process with the host device 210. Further, if a rights object search request is received from the host device 210, the control module 222 may search for the rights object that can execute the corresponding content object through the content ID received with the rights object search request.

If the rights object is searched for, the control module 222 may extract information of the rights object. The rights object information may include a rights object ID, a storage position of a rights object in the storage module 224, use constraint information of a rights object, and copy constraint information of a rights object.

Meanwhile, if plural rights objects are searched for, i.e., if plural rights objects that can execute the content object requested by the host device 210 are searched for, the control module 222 may extract rights object information of the respective rights objects.

The control module 222, having extracted the rights object information, transmits the extracted rights object information to the host device 210 as an answer to the rights object search request.

In another embodiment of the present invention, the control module 222 may transmit the rights object to the host device 210 as an answer to the rights object search request.

If a state information update request (as described above) is received from the host device 210, the control module 222 updates the state information of the rights object subject to the update using the state update information received with the state information update request. In this case, the control module 222 can update the rights object state information by replacing the existing rights object state information with the state update information. The rights object subject to update can be identified through the rights object identification information (for example, a rights object ID or rights object storage position information) received with the rights object update request.

As described, according to the digital rights management method and apparatus according to the present invention, a host device can effectively use a rights object stored in a portable storage device.

The exemplary embodiments of the present invention have been described with reference to the accompanying drawings. However, those skilled in the art will appreciate that many variations and modifications can be made to the disclosed embodiments without substantially departing from the principles of the present invention. Therefore, the disclosed embodiments of the invention are used in a generic and descriptive sense only and not for purposes of limitation.

What is claimed is:

1. A method for digital rights management, comprising:
requesting a portable storage device to search for a rights object that can execute a specified content object;
selecting a rights object to be consumed by confirming information about the rights object received from the portable storage device as a result of the request; and
executing the content object by consuming the selected rights object.

2. The method of claim 1, wherein the information about the rights object includes at least one of an ID of the rights object that can execute the content object, storage position information of the rights object, use constraint information of the rights object, copy constraint information of the rights object, and state information of the rights object.

3. The method of claim 2, wherein the information about the rights object further includes the rights object that can execute the specified content object.

4. The method of claim 2, wherein the executing the content object comprises:
requesting transmission of the selected rights object using identification information of the selected rights object; and
executing the content object by consuming the rights object received from the portable storage device as a result of the transmission request.

5. The method of claim 4, wherein the identification information includes at least one of the ID of the selected rights object and the storage position information of the selected rights object.

6. The method of claim 1, further comprising:
creating state update information that indicates an available state of the consumed rights object changed according to consumption of the selected rights object; and
requesting an update of the state information of the consumed rights object to the portable storage device using the created state update information and the identification information of the consumed rights object.

7. The method of claim 6, wherein the identification information includes at least one of ID of the consumed rights object and storage position information of the consumed rights object.

8. A method for digital rights management, comprising:
receiving a request for searching for a rights object that can execute a specified content object from a host device;
searching the rights object that can execute the content object; and
transmitting the searched rights object and information about the searched rights object to the host device.

9. The method of claim 8, wherein the information about the searched rights object includes at least one of an ID of the searched rights object, storage position information of the searched rights object, use constraint information of the searched rights object, copy constraint information of the searched rights object and state information of the searched rights object.

10. The method of claim 9, wherein the transmitting comprises:
extracting the information about the searched rights object and transmitting the extracted information to the host device;
receiving identification information of the rights object, of which the transmission is requested, from the host device together with a request for transmission of the rights object; and
searching the rights object, of which the transmission is requested, through the identification information, and transmitting the searched rights object to the host device.

11. The method of claim 10, wherein the identification information includes at least one of the ID of the rights object of which the transmission is requested and the storage position information of the rights object of which the transmission is requested.

12. The method of claim 9, further comprising:
receiving a state information update request of a consumed rights object from the host device, wherein the state information update request includes state update information indicating an available state of the consumed rights object according to consumption of the transmitted rights object by the host device and the identification information of the consumed rights object; and
updating the state information of the consumed rights object.

13. The method of claim 12, wherein the rights object subject to the state information update is searched for using the identification information of the consumed rights object.

14. The method of claim 12, wherein the identification information includes at least one of the ID of the consumed rights object and the storage position information of the consumed rights object.

15. The method of claim 13, wherein update of the state information is performed by replacing the state information of the rights object searched for during the update of the state information with the state update information.

16. A host device comprising:
an interface module that connects with a portable storage device;
a control module that sends a request for a search for a rights object that can execute a specified content object to the portable storage device through the interface module; and
a content execution module that executes the content object by consuming a rights object received from the portable storage device through the interface module as a result of the request.

17. The host device of claim 16, wherein the control module requests transmission of the rights object to be consumed using an ID of the content object to be executed or identification information of the rights object to be consumed.

18. The host device of claim 17, wherein the identification information includes at least one of the ID of the rights object to be consumed and the storage position information of the rights object to be consumed.

19. The host device of claim 17, wherein the identification information is obtained using information about the rights object received from the portable storage device through the interface module as a result of the request.

20. The host device of claim 19, wherein the information about the rights object includes at least one of an ID of the rights object, storage position information of the rights object, use constraint information of the rights object, copy constraint information of the rights object and state information of the rights object.

21. The host device of claim 16, further comprising an update information creation module which creates state update information indicating an available state of the consumed rights object that is changed as the content execution module executes the content object.

22. The host device of claim 21, wherein the control module sends a request for an update of state information of the consumed rights object to the portable storage device through the interface module by using the created state update information and identification information of the consumed rights object.

23. The host device of claim 22, wherein the identification information includes at least one of the ID of the consumed rights object and the storage position information of the consumed rights object.

24. A portable storage device comprising:
an interface module that connects with a host device;
a storage module that stores rights objects and state information of the rights objects; and
a control module that searches for a rights object, which can execute a specified content object, stored in the storage module according to a request for searching for the rights object received from the host device connected through the interface module, and that transmits the searched rights object to the host device through the interface module.

25. The portable storage device of claim 24, wherein a search for the rights object is performed using an ID of the specified content object or identification information about the rights object received with a request from the host device.

26. The portable storage device of claim 25, wherein the identification information includes at least one of ID of the rights object and storage position information of the rights object.

27. The portable storage device of claim 24, wherein if a search for the rights object is requested, the control module searches for the rights object that can execute the content object, extracts information about the searched rights object and transmits the extracted information to the host device through the interface module.

28. The portable storage device of claim 27, wherein the information about the rights object includes at least one of an ID of the rights object, storage position information of the rights object, use constraint information of the rights object, copy constraint information of the rights object and state information of the rights object.

29. The portable storage device of claim 24, wherein if the interface module receives a state information update request of the consumed rights object from the host device, the control module updates the state information of the consumed rights object by using state update information received with the state information update request and the identification information of the consumed rights object subject to update.

30. The portable storage device of claim 29, wherein the identification information includes at least one of the ID of the rights object subject to update and storage position information of the rights object subject to update.

31. The portable storage device of claim 29, wherein the rights object subject to update is searched for using the identification information of the rights object.

32. The portable storage device of claim 29, wherein the state information is updated by replacing the state information of the rights object subject to update with the state update information.

33. The portable storage device of claim 29, wherein the state update information is information that indicates an available state of the consumed rights object according to consumption of the transmitted rights object by the host device.
